(19) United States
(12) Patent Application Publication
(10) Pub. No.: US 2025/0301406 A1
(43) Pub. Date: Sep. 25, 2025

(54) Role-Based Target Wake Time

(71) Applicant: Arista Networks, Inc., Santa Clara, CA (US)

(72) Inventors: Balram Ketan Vakil, Bengaluru (IN); Asvin Kumar Muthurangam, Bangalore (IN)

(21) Appl. No.: 18/613,614

(22) Filed: Mar. 22, 2024

(51) Int. Cl. H04W 52/02

(52) U.S. Cl. CPC H04W 52/0216

(57) ABSTRACT

A wireless access point may be wirelessly connected to first and second sets of client devices having different roles. The wireless access point may selectively perform negotiations and/or provide services based on the role of the client device.

### BACKGROUND

A communication system includes multiple network devices that are interconnected to form a network for conveying network traffic between hosts. The network devices at the edge portions of the network can include wireless access points that provide wireless connectivity for the hosts (e.g., client devices). Numerous client devices can be wirelessly connected to a wireless access point. This can strain services for the client devices provided by the wireless access point.

### BRIEF DESCRIPTION OF THE DRAWINGS

FIG. 1 is a diagram of an illustrative network having wireless access point(s) to which hosts associated with different roles are connected in accordance with some embodiments.

FIG. 2 is a diagram of an illustrative wireless access point in accordance with some embodiments.

FIG. 3 is a diagram of an illustrative wireless access point configured to selectively perform negotiations with client devices in accordance with some embodiments.

FIG. 4 is a diagram of illustrative communications for accepting a target wake time negotiation in accordance with some embodiments.

FIG. 5 is a diagram of illustrative communications for rejecting a target wake time negotiation in accordance with some embodiments.

FIG. 6 is a diagram of an illustrative connected client device database containing role information in accordance with some embodiments.

FIG. 7 is a diagram of an illustrative state of the connected client device database in which negotiations are enabled for preferred and non-preferred client devices in accordance with some embodiments.

FIG. 8 is a diagram of an illustrative state of the connected client device database in which negotiations are selectively enabled for preferred client devices in accordance with some embodiments.

FIG. 9 is a flowchart of illustrative operations for performing target wake time negotiations based on client device role information in accordance with some embodiments.

### DETAILED DESCRIPTION

A network can convey network traffic, e.g., in the form of frames, packets, etc., between hosts. These hosts may include client devices wirelessly coupled to wireless access points in the network and, through the wireless access points, may be connected to other network devices that form a wired portion of the network.

Client devices and wireless access points may negotiate for services provided by the wireless access points. As one illustrative example described herein, some wireless access points and client devices may be configured to negotiate for power management services such as a target wake time (TWT) negotiation for providing negotiated time periods during which a client device transmits uplink data to and/or receives downlink data from a wireless access point. By scheduling service time period(s) for uplink and/or downlink with the wireless access point, the client device may operate with a low-power state (e.g., may sleep, may be turned off, etc.) between adjacent service periods and at other suitable times. The TWT negotiation and operation described herein may be a Target Wake Time negotiation and operation as specified by the IEEE 802.11ax standard or may be other (customized or non-standardized) types of TWT negotiation and operation generally for providing time periods for a client device to transmit uplink data to and/or receive downlink data from a wireless access point.

While a wireless access point can negotiate and provide services (e.g., TWT operations) for multiple client devices, an excessive number of client devices being connected to the wireless access point (or more specifically to a service set identifier (SSID) of the wireless access point), may hinder the wireless access point's ability to effectively provide services to all connected client devices. In the example of providing TWT operations for client devices, an excessive number of connected client devices may be detrimental to the performance of TWT operations by the wireless access point because of increased scheduling overhead, because the numerous client devices have to contend for a limited number of service periods, etc.

In these scenarios and/or in other scenarios, a wireless access point may be configured to preferentially accept (e.g., perform and complete) negotiations with first client devices connected to an SSID of the wireless access point and to provide the negotiated services (e.g., TWT operations) for the first client devices. Conversely, the wireless access point may be configured to reject negotiations with second client devices connected to the same SSID and not provide the services (e.g., TWT operations) for the second client devices. To facilitate these operations, the wireless access point may obtain client device role information (e.g., device user role information) for any connected client devices and discriminate between the first and second client devices, e.g., for the purposes of accepting or rejecting negotiations, based on the client device role information.

While embodiments described herein sometimes use TWT negotiations and TWT operations as examples of negotiations between an access point and client devices and as examples of services provided based on the negotiations, this is merely illustrative. If desired, an access point may be configured to selectively accept other types of negotiations and perform other negotiated services based on client device role information.

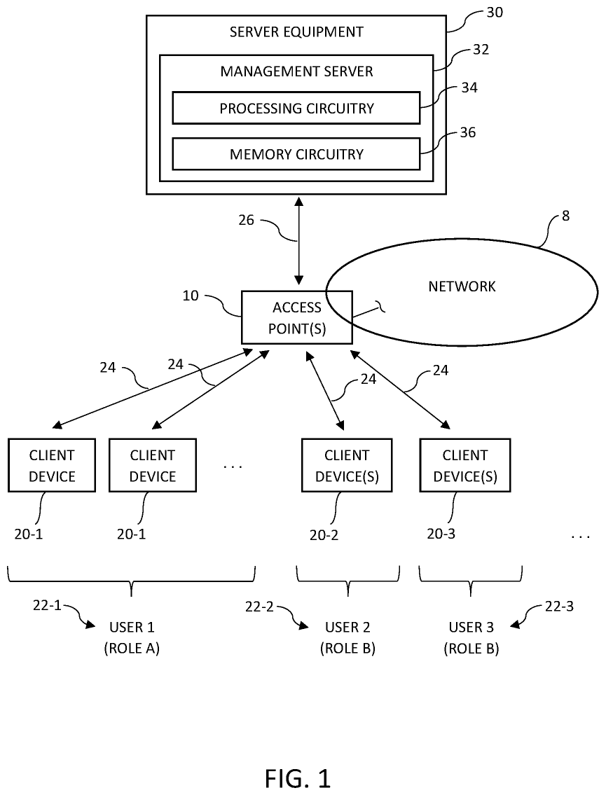

An illustrative networking system containing one or more access points configured to selectively perform negotiations and/or provide negotiated services to client devices based on client device role information is shown in FIG. 1. In the example of FIG. 1, a networking system may include a network such as network 8. Network 8 may be of any suitable scope and/or form part of a larger network of any suitable scope. As examples, network 8 may include, be, and/or form part of one or more local segments, one or more local subnets, one or more local area networks (LANs), one or more campus area networks, a wide area network, etc. If desired, network 8 may include internet service provider networks (e.g., the Internet) or other public service provider networks, private service provider networks (e.g., multiprotocol label switching (MPLS) networks), and/or any other types of networks such as telecommunication service provider networks.

In configurations sometimes described herein as an example, network 8 may include a wired network portion based on wired technologies or standards such as Ethernet (e.g., using copper cables and/or fiber optic cables) and a wireless network portion such as wireless local area networks (WLANs) (e.g., Wi-Fi networks compliant with the IEEE 802.11 family of standards).

Network 8 may be implemented using one or more network devices that handle (e.g., process by modifying, forwarding, etc.) network traffic to convey information for user applications between end hosts and/or generally for applications between devices. In general, network 8 can include networking equipment forming a variety of network devices that interconnect end hosts of network 8. These network devices of network 8 may include one or more wireless access points, one or more switches (e.g., multi-layer (Layer 2 and Layer 3) switches, single-layer (Layer 2) switches, etc.), one or more bridges, one or more routers or gateways, one or more hubs, one or more repeaters, one or more firewalls, one or more devices serving other networking functions, one or more devices that include the functionality of two or more of these devices, and/or management equipment that manage and control the operation of one or more of these network devices.

End hosts of network 8 can include computers, servers, portable electronic devices such as cellular telephones and laptops, other types of specialized or general-purpose host computing equipment (e.g., running one or more client-side and/or server-side applications), network-connected appliances or devices such as cameras, thermostats, wireless sensors, medical, health, or other sensors, lighting fixtures, speakers, printers, controllers, and other network-connected equipment that serve as input-output devices and/or computing devices in the distributed networking system, devices used by network administrators (sometimes referred to as administrator devices), network service devices, management equipment that manage and control the operation of one or more of other end hosts and/or network devices.

Configurations in which network 8 includes one or more wireless access points 10 that implement a wireless network (portion) for network 8 are sometimes described herein as an illustrative example. In these configurations, the end hosts connected to network 8 via wireless access points 10 are often referred to as client devices or client stations (e.g., client devices or client stations 20 in FIG. 1). Each wireless access point 10 may provide one or more service set identifiers (SSIDs) to which client devices 20 can connect. Multiple wireless access points 10 may provide the same SSID. Multiple client devices 20 may wirelessly connect to each SSID provided by one or more wireless access points 10.

To assist in the operations of wireless access points 10 (e.g., the authentication of client devices for network access, the authentication of user identity, and/or to generally assist in the authorization of network access of client devices 20 to network 8), one or more servers implemented on server equipment 30 may be communicatively coupled to wireless access points 10 (e.g., through network paths in network 8). An illustrative management server 32 (e.g., a network access management server) may be implemented on server equipment 30. Management server 32 may be formed from any suitable number of compute devices on server equipment 30 and any suitable number of storage devices on server equipment 30, among other elements of equipment 30 such as input-output interfaces, power management circuitry, thermal management circuitry, etc. Compute devices for implementing management server 32 may generally be referred to herein as processing circuitry 34 and storage devices for implementing management server 32 may generally be referred to herein as memory circuitry 36.

Server equipment 30 may include server hardware such as one or more blade servers, one or more rack servers, and/or one or more tower servers. Configurations in which server equipment 32 includes one or more rack servers mounted to racks of a server chassis or enclosure are sometimes described herein as an illustrative example. Each of the compute devices for processing circuitry 34 and/or each of the storage devices for memory circuitry 36 may be provided as part of the server hardware (e.g., as part of the rack servers).

Processing circuitry 34 (e.g., the compute devices of server equipment 30) may include one or more processors or processing units such as central processing units (CPUs), graphics processing units (GPUs), microprocessors, general-purpose processors, host processors, microcontrollers, digital signal processors, programmable logic devices (e.g., field programmable gate array (FPGA) devices), application specific system processors (ASSPs), application specific integrated circuit (ASIC) processors, and/or other types of processors or processing units. Memory circuitry 36 (e.g., the storage devices of server equipment 30) may include volatile memory such as dynamic random-access memory, static random-access memory, etc., non-volatile memory such as hard-drive storage, solid-state storage, flash memory, etc., and/or other types of memory circuitry. Accordingly, memory circuitry 36 may include non-transitory (tangible) computer-readable storage media that stores the operating system software and/or any other software code, sometimes referred to as program instructions, software, data, instructions, or code.

Processing circuitry 34 may run (e.g., execute) an operating system and/or other software and firmware that are stored on memory circuitry 36 to perform desired operations of server 32. In such a manner, server equipment 30 may implement one or more services, one or more software servers, and/or other software features to collectively perform the functions of management for server 32 and/or the functions of other servers implemented thereon. As described herein, management server 32 refers to the underlying server (hardware) equipment and/or the server software (e.g., services) executed thereon to perform the operations of server 32.

While management server 32 is sometimes described herein as being configured to authenticate network access of client device(s) 20 and/or authenticate identities of client device user(s) 22 (e.g., by performing device and user onboarding, by performing generation and storage of user and device role information, by communicating with access points 10 to perform network access authentication, etc.), this is merely illustrative. If desired, server 32 may be additionally or alternatively configured to perform other functions

Server 32 may be communicatively coupled to and communicate with network devices of network 8 such as wireless access points 10 via communication paths 26. Communication paths 26 may include (wired) network paths through network 8 (e.g., through the network devices therein, using the Internet, etc.). In illustrative configurations described herein, an edge portion of network 8 may be implemented with wireless access points 10. Accordingly, communication paths 24 may be implemented as wireless communication links between respective wireless communication circuitry on client devices 20 and access points 10. While wireless access points 10 are shown in FIG. 1 as being outside of network 8, this is merely illustrative. As described above, access points 10 may form a part of network 8 (e.g., may form a wireless network portion of network 8).

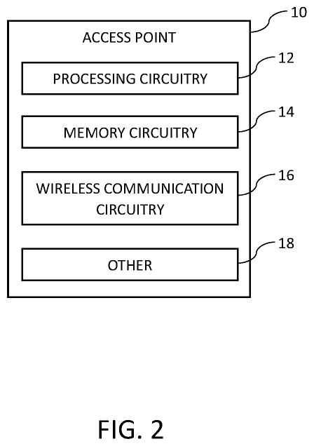

FIG. 2 is a diagram of an illustrative hardware configuration for a network device such as each wireless access point 10 in FIG. 1. As shown in FIG. 2, wireless access point 10 may include processing circuitry 12, memory circuitry 14, wireless communication circuitry 16, and other components 18 such as input-output interfaces or ports.

Processing circuitry 12 may include one or more processors or processing units such as general-purpose processors (e.g., a central processing unit (CPU)), microprocessors, microcontrollers, digital signal processors, programmable logic devices (e.g., field-programmable gate array (FPGA) devices), application specific system processors (ASSPs), application specific integrated circuit (ASIC) processors, graphics processing units (GPUs), and other types of processors or processing units. Memory circuitry 14 may include volatile memory such as dynamic random-access memory, static random-access memory, etc., non-volatile memory such as hard-drive storage, solid-state storage, flash memory, etc., and/or other types of memory circuitry.

In general, the operations of wireless access point 10 described herein may be stored as (software) instructions on one or more non-transitory computer-readable storage media (e.g., part of memory circuitry 14) in wireless access point 10. The corresponding processing circuitry (e.g., processing circuitry 12) in wireless access point 10 for these one or more non-transitory computer-readable storage media may process the respective instructions to perform the corresponding wireless access point operations. At least some portions of processing circuitry 12 and at least some portions of memory circuitry 14 may be coupled to each other and may, collectively, sometimes be referred to herein as the control circuitry of wireless access point 10 because the two portions are often collectively used to control or use one or more other components of wireless access point 10 (e.g., by exchanging requests, responses, control signals, data, and/or other information with the one or more other components) to perform wireless access point operations.

Wireless access point 10 may include wireless communication circuitry 16 configured to wirelessly communicate with client devices 20 (FIG. 1) and generally provide wireless communication capabilities. Wireless communication circuitry 16 may include one or more radios (e.g., Wi-Fi radios), radio-frequency transceiver circuitry, radio-frequency front-end circuitry, and one or more antennas. The one or more radios may use the one or more antennas to transmit radio-frequency signals to and receive radio-frequency signals from one or more client devices 20. While wireless communication circuitry 16 is shown as a separate element from processing circuitry 12, this is merely illustrative. If desired, portions of wireless communication circuitry 16 (e.g., radio functionalities) may be implemented as a portion of processing circuitry 12.

Access point 10 may include other components 18 such as one or more input-output interfaces or ports (on which the interfaces are implemented). As an example, these ports may include Ethernet ports or other types of network interfaces that generally provide wired connectivity to other network elements in network 8 (e.g., switches, routers, modems, controllers, servers, client devices, etc.), management ports through which wireless access point 10 is controlled and managed, power ports through which power is supplied to wireless access point 10, and/or other types of ports. In general, these input-output components 18 and/or wireless communication circuitry 16 may provide external communication interfaces (e.g., Bluetooth interfaces, Wi-Fi interfaces, Ethernet interfaces, optical interfaces at one or more optical ports, and/or other networking interfaces) for connecting wireless access point 10 to a wireless local area network, a local area network, the Internet, a wide area network, a mobile network, other types of networks, and/or to external devices such as other network device(s) in network 8, client device(s) 20, peripheral devices (e.g., a display), and/or other external equipment.

If desired, other components 18 on wireless access point 10 may include other input-output devices such as devices that provide user output such as a display device (e.g., one or more status lights) and/or devices that gather user input such as one or more buttons. If desired, other components 18 on wireless access point 10 may include one or more sensors such as radio-frequency sensors. If desired, wireless access point 10 may include other components 18 such as a system bus that couples the internal components of wireless access point 10 to one another, to power management components, etc. In general, each component within wireless access point 10 may be interconnected to the control circuitry (e.g., to processing circuitry 22 and/or memory circuitry 24) in wireless access point 10 via one or more paths that enable the reception and transmission of control signals, data, and/or other information.

One or more wireless access points 10 can negotiate with client devices 20 (FIG. 1) wirelessly connected to the same SSID to provide various services for the connected client devices 20 (e.g., power saving operations, uplink and/or downlink scheduling services, etc.). Configurations in which wireless access points 10 and the connected client devices 20 have TWT capabilities (e.g., capabilities to perform TWT in a manner specified by the IEEE 802.11ax standard or in a non-standardized manner) and perform TWT negotiations are sometimes described herein as illustrative examples. If desired, wireless access points 10 and the connected client devices 20 may perform negotiations (e.g., request and response messages, handshaking, etc.) for other types of services or operations. If desired, wireless access points 10 as described herein may also be wirelessly connected to client devices 20 without TWT capabilities (while performing the role-based TWT operations for other client devices 20 described herein).

TWT operations provide a technique by which client devices 20 can improve their power performance (e.g., decrease power consumption) by scheduling service period(s) with wireless access points 10 during which downlink data is received and/or uplink data transmitted, thereby allowing client device to sleep (e.g., operating in a low-power or sleep mode) between adjacent service period(s). However, the presence of numerous client devices on the same SSID can be detrimental to the performance of TWT operations by wireless access points 10 (e.g., because of the increased scheduling overhead, because the numerous client devices have to contend for a limited number service periods, etc.). In these instances and/or in other instances, it may be desirable for one or more wireless access points 10 to preferentially schedule TWT operations with certain client devices and not with other client devices on the same SSID.

Referring back to FIG. 1, different client devices 20 of network 8 may be associated with different client device roles (e.g., different user roles associated with users of these client devices 20). In the example of FIG. 1, client devices 20-1 may belong or be operated by user 22-1 having a first role (e.g., role A associated with an identity of user 22-1), client devices 20-2 may belong to or be operated by user 22-2 having a second role (e.g., role B associated with an identity of user 22-2), and client devices 20-3 may belong to or be operated by user 22-3 having the second role (e.g., role B also associated with an identity of user 22-3). Accordingly, client devices 20-1 may be associated with role A, and client devices 20-2 and 20-3 may be associated with role B. While device roles based on their users' identities are illustrated in FIG. 1, client devices may also inherently have different roles (e.g., not based on who their users are, based on device type, based on device configuration, etc.). User identity based roles and inherent device roles are both referred to herein as device roles (sometimes referred to herein as device role information) because both types of roles can contribute to the process of determining different classes of client devices.

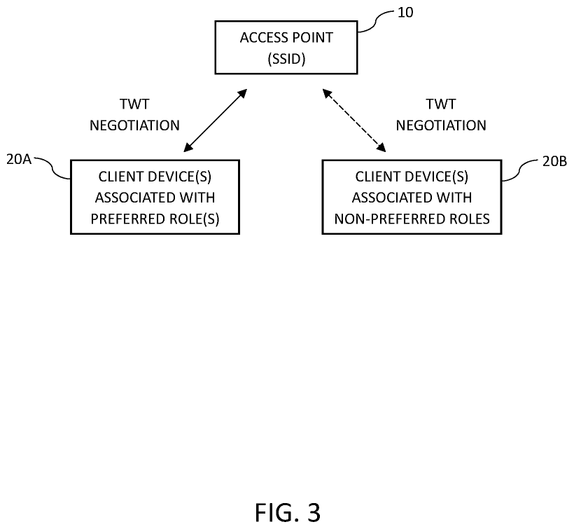

Wireless access point(s) 10 may be configured to preferentially provide network services (e.g., power-saving services such as with TWT) based on device role information by negotiating with and/or providing services for some client devices (e.g., a first set or class of client devices 20) and not negotiating with and/or not providing services for other client devices (e.g., a second set or class of client devices). FIG. 3 provides an illustrative example in which TWT negotiations are selectively performed based on device role information. This example based on TWT is merely illustrative. If desired, other types of negotiations (e.g., for non-standardized power saving services, for non-standardized uplink and/or downlink scheduling services, etc.) between client devices and access points may similarly be selectively performed based on device role information.

In the example of FIG. 3, an illustrative wireless access point 10 may provide an SSID for wireless connectivity. Multiple client devices 20 may be wirelessly connected to the SSID and wireless access point 10. The connected client devices 20 may include one or more client devices 20A associated with one or more preferred device roles and may include one or more client devices 20B associated with one or more non-preferred roles.

Examples of preferred client devices 20A and preferred nature of their roles may include one or more client devices whose users have role(s) that are prioritized by the (wireless) network configuration (e.g., user role is an employee of a company network, user role is a student or faculty of a college campus network, etc.), may include one or more client devices whose device role (e.g., device type) would benefit more from power savings (e.g., device role is an Internet-of-Things (IoT) device, device role is a cellular telephone or other small portable electronic device, etc.), and/or may include any suitable customizable list of client devices (e.g., based on network administrator input).

Non-preferred client devices 20B and non-preferred nature of their roles may generally include any client devices other than the preferred client devices or any roles other than preferred roles. In particular, whereas preferred device roles may include user roles that are identified in a network access authentication database or a system directory, non-preferred devices roles may include user roles that are absent from the network access authentication database or the system directory.

If desired, non-preferred client devices 20B and the non-preferred nature of their roles may be explicitly defined, rather than being defined as the complement of preferred client devices 20A. Examples of non-preferred client devices 20B may include one or more client devices whose users are guests to a company network or visitors to a college campus network, may include one or more client devices whose device role (e.g., device type) would benefit less from power savings (e.g., device role is an electronic device that receives power from a wall outlet), and/or may include any suitable customizable list of client devices (e.g., based on network administrator input). If desired, non-preferred device roles may also be included as user roles identified in a network access authentication database or a system directory.

As shown in FIG. 3, wireless access point 10 is configured to selectively perform and complete (e.g., to accept) TWT negotiations with one or more preferred client devices 20A associated with preferred role(s). Wireless access point 10 may further be configured to selectively not perform or not complete (e.g., to reject) TWT negotiations with one or more non-preferred client devices 20B associated with non-preferred role(s).

In some illustrative configurations described as an example, wireless access point 10 may operate with one or more non-preferred client devices 20B to perform other types of power saving operations such as a power save mode (e.g., a Power Save Mode specified by the IEEE 802.11 standard) after rejecting TWT negotiations with the one or more non-preferred client devices 20B.

If desired, wireless access point 10 may perform and complete (e.g., accept) TWT negotiations with non-preferred client devices 20B (in addition to preferred client devices 20A) in some scenarios such as when a number of preferred client devices are connected to wireless access point 10 is less than a threshold, when a total number of client devices are connected to wireless access point 10 is less than a threshold, when wireless access point 10 has processor and/or memory utilization is below threshold utilization value(s), or generally when wireless access point 10 is able to support negotiated services for all connected and capable client devices, when a user-configured condition is triggered, and/or when one or more other criteria are satisfied. In other words, when wireless access point 10 determines that one or more of these types of criteria are satisfied, wireless access point 10 may perform and complete (e.g., accept) TWT negotiations with preferred client devices 20A and non-preferred client devices 20B. Otherwise (e.g., when wireless access point 10 determines that one or more of these types of criteria are not satisfied), wireless access point 10 may selectively perform and complete (e.g., accept) TWT negotiations with preferred client devices 20A and selectively not perform or not complete (e.g., reject) TWT negotiations with non-preferred client devices 20B.

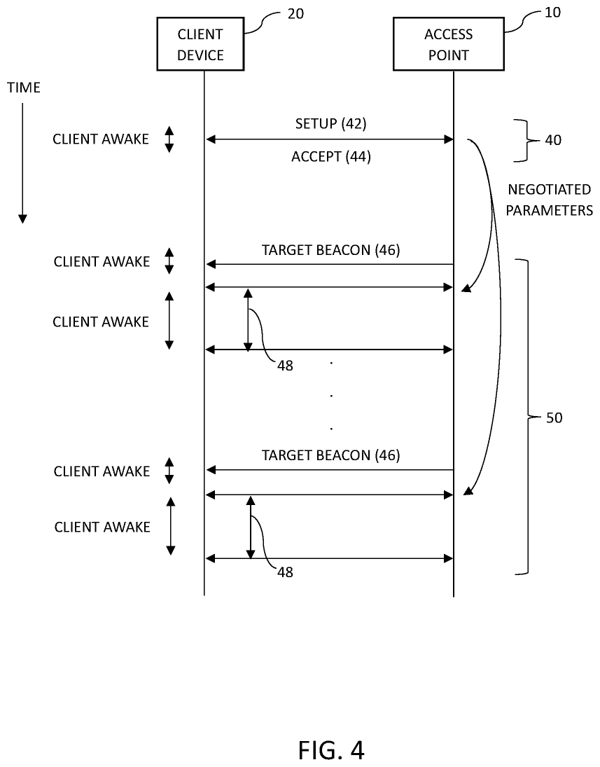

FIG. 4 is an illustrative timing diagram for an illustrative negotiation 40 in which wireless access point 10 accepts and/or completes negotiation 40 (e.g., a TWT negotiation) requested by client device 20 for a service 50 provided by wireless access point 10. Subsequently, wireless access point 10 may provide service 50 for client device 20 (e.g., to perform a TWT operation) based on parameters agreed upon during negotiation 40. Client device 20 in FIG. 4 may be a preferred client device such as device 20A in FIG. 3 or may be a non-preferred client device such as device 20B in FIG. 3 (e.g., when a less-than-threshold number of preferred or total client devices are connected to wireless access point 10 and/or when one or more other criteria described in connection with FIG. 3 are satisfied). The messages and/or data described in connection with FIG. 4 (or generally between access point 10 and client device 20) may be conveyed using corresponding wireless communication circuitry on wireless access point 10 and client device 20 (e.g., wireless communication circuitry 26 in FIG. 2) over a wireless connection.

In the example of FIG. 4, client device 20 and wireless access point 10 may perform negotiation 40 by exchanging one or more setup messages 42 (e.g., TWT setup message(s)). In one illustrative configuration (e.g., based on a unicast solicited negotiation scheme), client device 20 may send a request message (e.g., as setup message 42) to wireless access point 10. Wireless access point 10 may respond with a response message to client device 20. The response message may be an accept message 44 (indicating an acceptance or agreement of negotiation). One or more of these messages (e.g., request or other types of setup message and accept or other types of response messages) may include requested, specified, or generally negotiated parameters for providing service 50. In the example in which service 50 is a TWT operation, setup message 42 and/or accept message 44 may include indications of (e.g., parameters specifying) one or more scheduled time periods for target client device wake times that have been agreed upon between client device 20 and wireless access point 10. Based on the agreed upon service parameters, negotiation 40 is considered to be completed.

In the example of TWT operation, the negotiated parameters may schedule one or more time periods for TWT each beginning with a corresponding target beacon message sent by wireless access point 10 and received by client device 20 and each containing a TWT service time period 48 during which uplink data and/or downlink data are conveyed between wireless access point 10 and client device 20. Accordingly, client device 20 may be in an awake state (e.g., a normal or high-power state) only or mostly during the scheduled TWT time periods, thereby increasing the periods of time between the awake times during which client device 20 is in a sleep state (e.g., a low-power state).

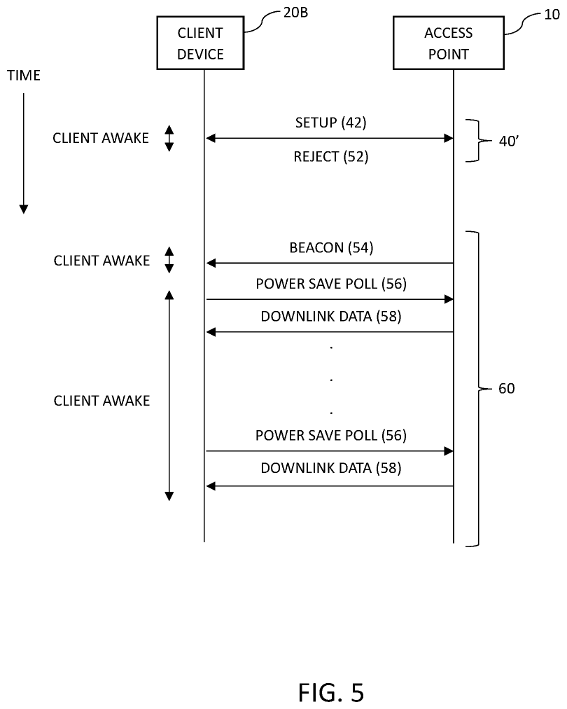

FIG. 5 is an illustrative timing diagram of an illustrative negotiation 40′ in which wireless access point 10 rejects and/or does not complete negotiation 40′ (e.g., a TWT negotiation) requested by client device 20B for a service (e.g., TWT operation 50 in FIG. 4) provided by wireless access point 10. Subsequently, based on the rejected or otherwise incomplete negotiation with wireless access point 10, client device 20B may default to performing other types of operations (e.g., another type of power saving operation 60). Client device 20B in FIG. 5 may be a non-preferred client device such as device 20B in FIG. 3 (e.g., when a greater-than-threshold number of preferred or total client devices are connected to access point 10 and/or when one or more other criteria described in connection with FIG. 3 are not satisfied). The messages and/or data described in connection with FIG. 5 (or generally between access point 10 and client device 20) may be conveyed using corresponding wireless communication circuitry on wireless access point 10 and client device 20 (e.g., wireless communication circuitry 26 in FIG. 2) over a wireless connection.

In the example of FIG. 5, client device 20B and wireless access point 10 may perform (e.g., attempt to perform by initiating) negotiation 40′ by exchanging one or more setup messages 42 (e.g., TWT setup message(s)). In one illustrative configuration (e.g., based on a unicast solicited negotiation scheme), client device 20B may send a request message (e.g., as setup message 42) to wireless access point 10. Wireless access point 10 may respond with a response message to client device 20B. However, in contrast to FIG. 4, the response message may be a reject message 52 or any other suitable message indicating that no parameters (for a service requested by client device 20B) have been agreed upon and/or the request for service has been rejected. In the example of TWT, the transmission of reject message 52 may indicate that time periods for TWT have not been allocated for client device 20B and TWT negotiation has been rejected or is incomplete. If desired, a lack of response from access point 10 may be used to indicate a rejected or incomplete negotiation.

In response to the failed negotiation 40′ for a primary or preferred power save operation (e.g., operation 50 in FIG. 4), client device 20B and wireless access point 10 may fall back to and perform an alternative power save operation. For example, client device 20B may send another message to wireless access point 10 indicating the initiation of a power save mode operation 60. As part of operation 60, data for client device 20B may be buffered (e.g., temporarily stored) at wireless access point 10. After a suitable amount of data has been buffered, wireless access point 10 may send beacon message 54 to client device 20B containing an indication of the buffered data. Subsequently, client device 20B may send a suitable number of power save poll messages 56 or other types of messages to prompt wireless access point 10 to transmit downlink data 58 in a piecewise manner (responsive to each message 56) as long as there is still any additional downlink data buffered at wireless access point 10. Client device 20B may be in an awake state (e.g., a normal or high-power state) to receive initial beacon message 54 and during downlink data 58 reception but may, thereafter, be in a sleep state (e.g., a low-power state). Client device 20B may wake periodically thereafter to detect additional beacon message(s) possibly indicative of further buffered data.

The use of power save mode operation 60 described in connection with FIG. 5 is merely illustrative. If desired, other types of operations may take place after the failed TWT negotiation 40′. More generally, in scenarios in which other types of negotiations for performing other types of services, other alternative types of services may instead be provided in place of operation 60 in FIG. 5. If desired, operation 60 may be omitted (e.g., even after the failed TWT negotiation 40′).

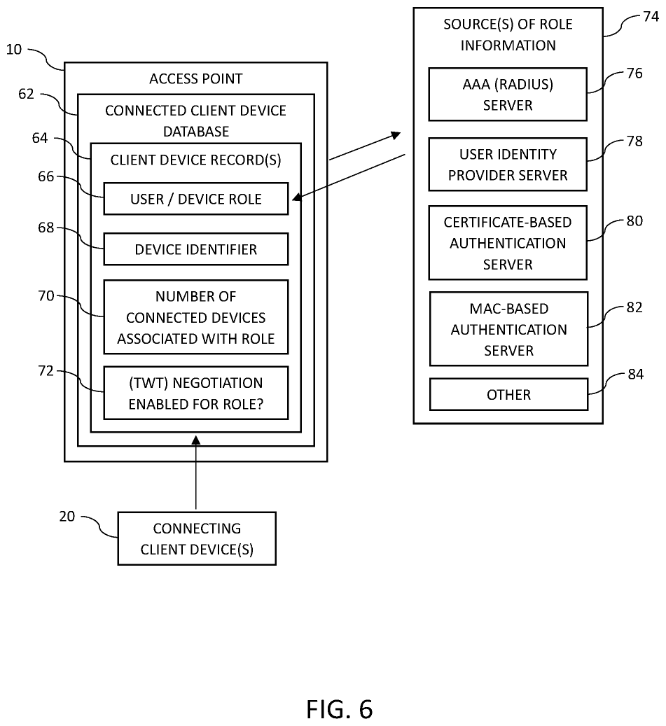

To determine whether the one or more criteria described in connection with FIG. 3 (e.g., a criterion, when satisfied, configures wireless access point 10 to begin selectively rejecting negotiations for connected non-preferred client devices 20B), wireless access point 10 may obtain (e.g., receive, generate, etc.) and/or maintain (e.g., store, update, etc.) information of currently connected client devices (e.g., updated as new client devices are connected, as existing client devices are disconnected, etc.). FIG. 6 is a diagram of an illustrative wireless access point 10 configured to maintain a connected client device database such as database 62 containing information (e.g., role information) for connected client device(s) 20. In particular, wireless access point 10 may store database 62 in memory circuitry 14 (FIG. 2) and/or in other manners generally accessible to processing circuitry 12 (FIG. 2).

For each client device 20 wirelessly connected to the same SSID and/or to wireless access point(s) 10 providing the SSID, wireless access point 10 may maintain a client device record 64 (sometimes referred to as entry 64) in database 62. A record 64 for a given client device 20 may include a client device role 66 associated with the given client device 20 (e.g., including a user role of the user of the given client device 20 as described in connection with FIGS. 1 and 3), a device identifier 68 (e.g., an address such as a Media Access Control (MAC) address) of the given client device 20, a number 70 of connected client devices 20 associated with the same role 66, and an indication 72 of whether negotiation for particular service (e.g., TWT negotiation) is enabled for the role 66 (e.g., whether wireless access point 10 will accept a newly received negotiation request message from a client device 20 of this role). Wireless access point 10 may also store (e.g., as part of database 62 or elsewhere) indications of which roles 66 in records 64 are preferred and/or non-preferred.

Wireless access point 10 may use one or more suitable sources 74 of role information to obtain the client device role information (e.g., user role information for the user of the client device) and to maintain (e.g., populate, update, etc.) the role 66 of records 64 in connected client device database 62. As examples, wireless access point 10 may obtain device role information as part of an access accept message received from an Authentication, Authorization, and/or Accounting (AAA) server 76 (e.g., based on the Remote Authentication Dial-In User Service (RADIUS) protocol) in response to an access request message containing user credentials (e.g., as part of a client device network access authentication operation), may obtain device role information from a user identity provider server 78 in response to providing user credentials for user identity authentication to server 78, may obtain device role information from a certificate-based authentication server 80 in response to providing a user certificate to server 80, may obtain device role information (e.g., indicative of a device type) from a MAC-based authentication server 82 in response to providing a MAC address of connected client device 20 to server 82, and/or may obtain user or device role information in other manners (e.g., using other sources or servers 84). As another example, wireless access point 10 may obtain device role information based on an association of device role information with a group-based or unique pre-shared key (PSK) received from client device 20 when connecting to wireless access point 10. The association may be stored locally on wireless access point 10 (e.g., on memory circuitry 14 in FIG. 2) or may be accessible at a server (e.g., server 32 in FIG. 1) that manages the group-based or unique PSKs. If desired, one or more servers 76, 78, 80, and 82, and/or other servers 84 that provide device role information may be implemented at least as a part of server 32 in FIG. 1.

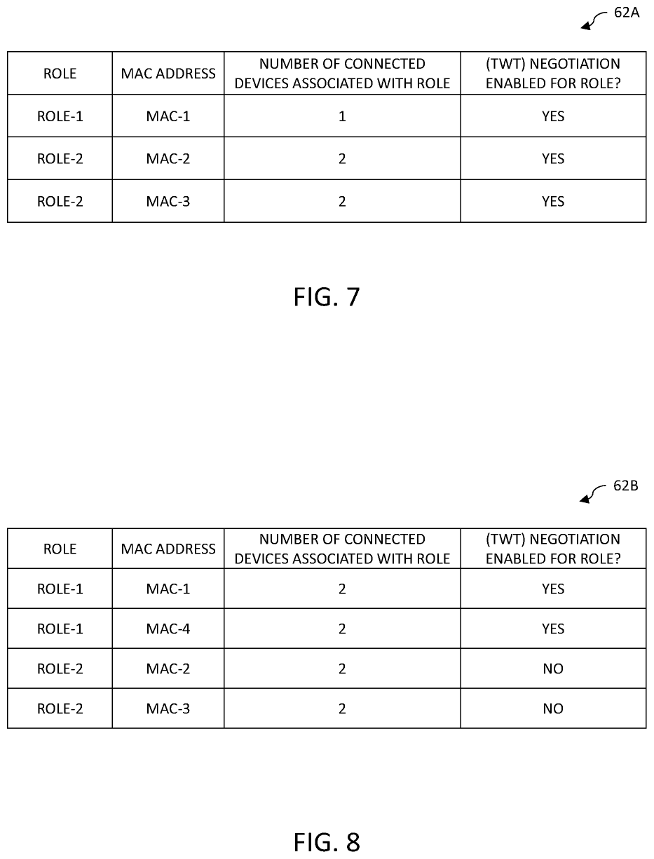

FIGS. 7 and 8 are two illustrative states of connected client database 62 (FIG. 6) at two corresponding illustrative times during the operation wireless access point 10. While the states of database 62 are illustrated in tabular form, this is merely illustrative. In general, records 64 and/or other information in database 62 may be stored in any suitable form and/or using any suitable data structure. In the representation shown of FIGS. 7 and 8, each row of the tables of FIGS. 7 and 8 (excluding the header row) may represent a corresponding record 64 for a connected client device 20 and each column of the tables of FIGS. 7 and 8 may represent a corresponding field of that record 64 (e.g., a field containing role 66, a field containing identifier 68, a field containing a number 70 of connected devices associated with the corresponding role 66, and a field containing whether negotiation is enabled for the corresponding role 66).

In the examples of FIGS. 7 and 8, device role ROLE-1 may be a preferred role associated with preferred client devices 20A (FIG. 3), while device role ROLE-2 may be a non-preferred role associated with non-preferred client devices 20B (FIG. 3). In the examples of FIGS. 7 and 8, wireless access point 10 may exhibit role-based selectivity for performing (TWT) negotiations and therefore (TWT) operations when the number of connected preferred client devices 20A is greater than or equal to two (e.g., corresponding to the criteria described in connection with FIG. 3). This threshold of two connected preferred client devices 20A is merely illustrative. If desired, the number of connected preferred client devices 20A for activating role-based selectivity for negotiations and operations may be any suitable number (e.g., five, three, or even zero, when role-based selectivity for negotiations and operations are always activated). If desired, other criteria may be used for activating role-based selectivity for negotiations and operations.

As shown in the table of FIG. 7, database state 62A includes three connected client devices 20: a first client device 20 having a preferred role of ROLE-1 and a MAC address of MAC-1, a second client device 20 having a non-preferred role of ROLE-2 and a MAC address of MAC-2, and a third client device having the non-preferred role of ROLE-2 and a MAC address of MAC-3. Because the total number of connected client devices having the preferred role of ROLE-1 is 1, the entry 64 for the first client device may indicate 1 as the total number of connected client devices having the same role of ROLE-1. Because the total number of connected client devices having the non-preferred role of ROLE-2 is 2, the entries 64 for the second and third client devices may each indicate 2 as the total number of connected client devices having the same role of ROLE-2.

In the example described above in connection with FIGS. 7 and 8, the threshold for wireless access point 10 discriminating between preferred client devices 20A and non-preferred client devices 20B (for the purposes of negotiation and/or services to be rendered) may be 2 total preferred client devices 20A being connected. Because the number of connected preferred client devices 20A is 1, which is less than the threshold of 2, (TWT) negotiations are enabled for both preferred client devices 20A and non-preferred client devices 20B (e.g., for first, second, and third client devices). In other words, client device 10 may perform the operations described in connection with FIG. 4 when any of the three client devices are requesting a (TWT) negotiation (e.g., as long as database state 62A remains unchanged).

At a later time, a new (fourth) client device 20 having the preferred role of ROLE-1 and a MAC address of MAC-4 may be connected to wireless access point 10 on the same SSID as the other three client devices 20 (described in connection with FIG. 7) while these three client devices remain connected. Accordingly, wireless access point 10 may update connected client device database 62 from state 62A in FIG. 7 to state 62B in FIG. 8.

As an example, wireless access point 10 may perform network access authentication for the fourth client device 20 (e.g., based on user credentials for the fourth client device 20, based on MAC address MAC-4 of the fourth client device 20, etc.) Based on the network access authentication, wireless access point 10 may obtain device role information for the fourth client device 20 (or more specifically, user role information based on the user credentials). The obtained device role information may be used to populate the entry 64 for the new fourth client device 20 to arrive at database state 62B in FIG. 8. With the inclusion of the new fourth client device 20, the number of connected preferred client devices 20A for the preferred role of ROLE-1 increases to 2 (e.g., the entries 64 for the first and fourth client devices may each indicate 2 as the total number of connected client devices having the same role of ROLE-1). This increase of connected preferred client devices 20A to 2 meets threshold of 2 total connected preferred client devices 20A for discriminating between preferred client devices 20A and non-preferred client devices 20B for the purposes of negotiation and/or services to be rendered (in this illustrative example). Accordingly, wireless access point 10 may perform role-based negotiations by disabling or rejecting (TWT) negotiations for non-preferred client devices 20B (e.g., having role ROLE-2) and still enabling or accepting (TWT) negotiations for preferred client devices 20A (e.g., having role ROLE-1).

In particular, while state 62B of database 62 remains unchanged, when the first or fourth preferred client device 20A sends a new (TWT) negotiation request message to wireless access point 10, wireless access point 10 may respond with a (TWT) negotiation accept message, thereby agreeing to subsequent time period(s) for providing a service (e.g., a TWT operation). In other words, wireless access point 10 may perform the operations described in connection with FIG. 4.

While state 62B of database 62 remains unchanged, when the second or third non-preferred client device 20B sends a new (TWT) negotiation request message to wireless access point 10 (e.g., after all previously scheduled TWT time periods have occurred or generally a previous (TWT) service session has expired), wireless access point 10 may respond with a (TWT) negotiation reject message, thereby refusing to provide a service. In other words, wireless access point 10 may perform the operations described in connection with FIG. 5 (e.g., an alternative power save mode operation may be performed).

Configurations in which unicast-type (or individual-type) TWT negotiations occur between wireless access point 10 and client device(s) 20 (e.g., in a solicited TWT negotiation scheme in which client device 20 initiates a TWT session setup or a TWT negotiation by sending the first setup message) are sometimes described herein as an example.

If desired, the role-based selectivity for TWT negotiation described herein may similarly be applicable to a broadcast TWT negotiation scheme or an unsolicited TWT negotiation scheme (e.g., a unicast-type TWT negotiation in which wireless access point 10 initiates a TWT session setup by sending the first setup message). Even in these configurations (e.g., broadcast TWT or unsolicited TWT schemes), wireless access point 10 may preferentially causes the initiation of TWT negotiations with one or more preferred client devices 20A while ignoring one or more non-preferred client devices 20B (e.g., when the role-based selectivity criterion described in connection with FIG. 3 is satisfied). In other words, when wireless access point 10 advertises a message containing a set of schedules (e.g., in a broadcast TWT scheme), the advertisement may be directed to only preferred client devices 20A (e.g., may be a multicast message, implemented using keys, encryption, and/or other techniques, rather than a broadcast message). Similarly, when wireless access point 10 is configured to initiate TWT negotiations with client devices 20 (e.g., in an unsolicited TWT scheme, by sending TWT response messages without receiving any TWT request messages), wireless access point 10 may send messages initiating TWT negotiations (e.g., by sending TWT response messages) to preferred client devices 20A and not non-preferred client devices 20B.

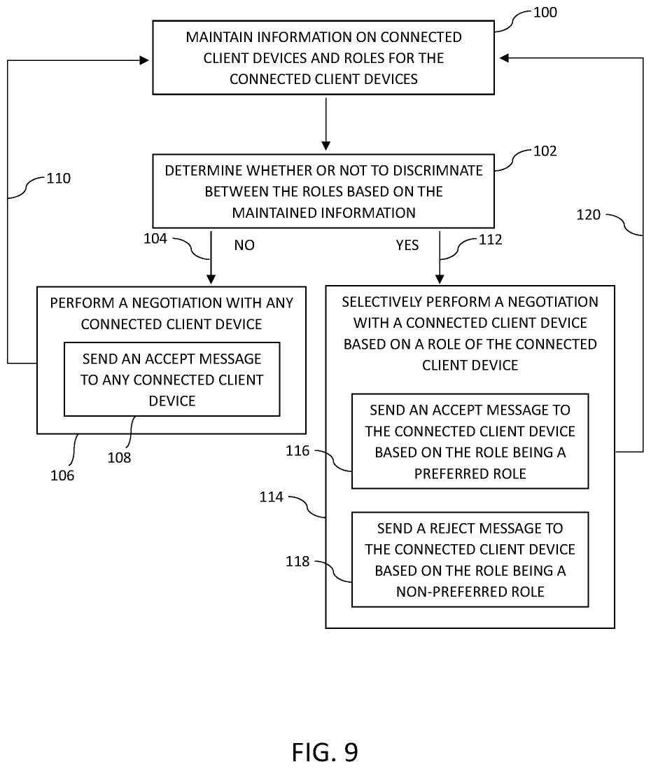

FIG. 9 is a flowchart of illustrative operations for operating a wireless access point to selectively perform client device role-based operations. These operations may be performed using one or more wireless access points 10 described in connection with FIGS. 1-8 and/or server 32 and/or other elements of the networking system in FIG. 1.

In configurations described herein as an illustrative example, the operations described in connection with FIG. 9 may be performed by control circuitry in access point 10 (e.g., performed by processing circuitry 12 in access point 10 by executing software instructions stored on memory circuitry 14 in FIG. 2) and/or performed by control circuitry in server 32 (e.g., performed by processing circuitry 34 for server 32 by executing software instructions stored on memory circuitry 36 in FIG. 1). If desired, one or more operations described in connection with FIG. 9 may be performed using other dedicated hardware components in access point 10 (e.g., by the control circuitry in access point 10 controlling or using these other dedicated hardware components such as wireless communication circuitry 26).

At block 100, processing circuitry of wireless access point 10 (e.g., processing circuitry 12 in FIG. 2) may maintain information on connected client devices and corresponding roles for the connected client devices. In particular, the processing circuitry may store and update the connected client device information (including device roles for the connected client devices) on memory circuitry 14 (FIG. 2), e.g., as database 62 and generally in the manner described in connection with FIGS. 6-8. The processing circuitry may receive the role information and/or other information from external sources (e.g., sources 74 in FIG. 6) using corresponding ports of access point 10 that are communicatively coupled to the external sources (e.g., through network devices in network 8). The processing circuitry may transmit request messages (e.g., to authenticate connecting client devices and/or their users) using these ports of access point 10 and may receive the role information in response to the transmitted request messages (e.g., as described in connection with FIG. 6).

At block 102, the processing circuitry may determine whether or not to discriminate between the different roles based on the maintained information. For example, the processing circuitry may be configured to indiscriminately accept negotiations with and/or provide services to all connected client devices in a first wireless network configuration (e.g., when one or more criteria for completing negotiation with even non-preferred client devices 20B are satisfied as described in connection with FIG. 3) and may be configured to selectively accept negotiations with and/or provide services to only a subset of all connected client devices in a second wireless network configuration (e.g., when one or more criteria for completing negotiation with even non-preferred client devices 20B are not satisfied as described in connection with FIG. 3).

The processing circuitry may determine whether or not to discriminate between the different roles based on determining whether or not these one or more criteria indicative of the first or second wireless network configuration are satisfied. These one or more criteria may include when a number of preferred client devices are connected to wireless access point 10 (e.g., part of the maintained information) is less than a threshold, when a total number of client devices are connected to wireless access point 10 (e.g., part of the maintained information) is less than a threshold, when wireless access point 10 has processor and/or memory utilization (e.g., part of the maintained information or as part of other information accessible to the processing circuitry) is below threshold utilization value(s), generally when wireless access point 10 is able (e.g., as determined based on the maintained information) to support negotiated services for all connected and capable client devices, when a user-configured condition (e.g., part of the maintained information or as part of other information accessible to the processing circuitry) is triggered and/or when one or more other criteria are satisfied.

If the processing circuitry determines not to discriminate between roles based on the maintained information, processing may proceed via path 104 from block 102 to block 106. As one illustrative example, the processing circuitry may determine that the maintained information (e.g., the state of database 62 in FIG. 6) has a state of the type shown in FIG. 7.

At block 106, the processing circuitry, using wireless communication circuitry of wireless access point 10 (e.g., wireless communication circuitry 26 in FIG. 2), may perform (e.g., accept) a negotiation indiscriminately with any (wirelessly) connected client device. More generally, the processing circuitry may provide a service indiscriminately to any connected client device. In some illustrative configurations described herein as an example, the negotiation may be a TWT negotiation and the service may be a TWT operation with scheduled TWT service periods for receiving uplink data from the client device and/or transmitting downlink data to the client device using the wireless communication circuitry.

The processing circuitry may generally use the wireless communication circuitry to transmit and receive messages via a wireless connection with the client device. The negotiation may occur over this wireless connection and/or the subsequent (negotiated) service may also be provided over this wireless connection.

As an illustrative part of block 106 described in connection with block 108, the processing circuitry, using the wireless communication circuitry, may send an accept message (e.g., message 44 in FIG. 4) in an unsolicited negotiation scheme, in a broadcast negotiation scheme, or in a solicited negotiation scheme (e.g., in response to receiving a setup message 42 in FIG. 4) to any connected client device (e.g., preferred and non-preferred client devices) to accept and/or complete a corresponding negotiation. In general, the processing circuitry may use the wireless communication circuitry to perform the TWT negotiations with preferred client device 20A and non-preferred client devices 20B as described in connection with FIG. 3, may use the wireless communication circuitry to accept negotiations and/or provide services such as TWT operations for all connected client devices 20 as described in connection with FIG. 4, and/or may use the wireless communication circuitry to perform the TWT negotiations with first, second, and third client devices as described in connection with FIG. 7.

Processing may further proceed via path 110 from block 106 back to block 100 (and/or block 102).

Referring back to block 102, if the processing circuitry determines to discriminate between roles based on the maintained information, processing may proceed via path 112 from block 102 to block 114. As one illustrative example, the processing circuitry may determine that the maintained information (e.g., the state of database 62 in FIG. 6) has a state of the type shown in FIG. 8.

At block 114, the processing circuitry, using the wireless communication circuitry, may selectively perform (e.g., accept or reject) a negotiation with a given (wirelessly) connected client device based on the role of the given connected client device (e.g., based on whether the role is part of one or more preferred roles or part of one or more non-preferred roles). More generally, the processing circuitry may provide a service selectively to a first set of (preferred) client devices having the one or more preferred roles and may refuse to provide a service a second set of (non-preferred) client devices having one or more non-preferred roles. In some illustrative configurations described herein as an example, the negotiation may be a TWT negotiation and the service may be a TWT operation with scheduled TWT service periods for receiving uplink data from the client device and/or transmitting downlink data to the client device using the wireless communication circuitry.

The processing circuitry may generally use the wireless communication circuitry to transmit and receive messages via a wireless connection with the client device. The negotiation may occur over this wireless connection and/or the subsequent (negotiated) service may also be provided over this wireless connection.

As an illustrative part of block 114 described in connection with block 116, the processing circuitry, using the wireless communication circuitry, may send an accept message (e.g., message 44 in FIG. 4) in an unsolicited negotiation scheme, in a broadcast negotiation scheme, or in a solicited negotiation scheme (e.g., in response to receiving a setup message 42 in FIG. 4) to a connected client device that is a preferred client device to accept and/or complete a corresponding negotiation. As another illustrative part of block 114 described in connection with block 118, the processing circuitry, using the wireless communication circuitry, may send a reject message (e.g., message 52 in FIG. 5) in an unsolicited negotiation scheme, in a broadcast negotiation scheme, or in a solicited negotiation scheme (e.g., in response to receiving a setup message 42 in FIG. 5) to a connected client device that is a non-preferred client device to reject and/or not complete a corresponding negotiation.

In general, the processing circuitry may use the wireless communication circuitry to accept TWT negotiations with preferred client device 20A and to reject TWT negotiations with non-preferred client devices 20B as described in connection with FIG. 3, may use the wireless communication circuitry to accept negotiations and/or provide services such as TWT operations to preferred client devices as described in connection with FIG. 4, may use the wireless communication circuitry to rejection negotiations and/or not provide services such as TWT operations to non-preferred client devices as described in connection with FIG. 5, and/or may use the wireless communication circuitry to enable TWT negotiations for the first and fourth client devices and to disable TWT negotiations for the second and third client devices as described in connection with FIG. 8.

Processing may further proceed via path 120 from block 114 back to block 100 (and/or block 102).

The methods and operations described above in connection with FIGS. 1-9 may be performed by the components of one or more wireless access points and/or server or other host equipment using software, firmware, and/or hardware (e.g., dedicated circuitry or hardware). Software code for performing these operations may be stored on one or more non-transitory computer-readable storage media (e.g., tangible computer-readable storage media) stored on one or more of the components of the wireless access point(s) and/or server or other host equipment. The software code may sometimes be referred to as software, data, instructions, program instructions, or code. The one or more non-transitory computer-readable storage media may include drives, non-volatile memory such as non-volatile random-access memory (NVRAM), removable flash drives or other removable media, other types of random-access memory, etc. Software stored on the one or more non-transitory computer readable-storage media may be executed by processing circuitry on one or more of the components of the wireless access point(s) and/or server or other host equipment (e.g., processing circuitry 34 in server 32 of FIG. 1, processing circuitry 12 in access point 10 in FIG. 2, etc.).

The foregoing is merely illustrative and various modifications can be made to the described embodiments. The foregoing embodiments may be implemented individually or in any combination.

What is claimed is:

1. A method of operating a wireless access point, the method comprising:
wirelessly connecting to a plurality of client devices;
maintaining role information for the plurality of client devices;
rejecting a target wake time (TWT) negotiation with a given client device in the plurality of client devices based on a role of the given client device indicated by the maintained role information.

2. The method defined in claim 1 further comprising:
accepting a TWT negotiation with an additional client device in the plurality of client devices based on a role of the additional client device indicated by the maintained role information.

3. The method defined in claim 2, wherein the maintained role information indicates a first user role of the given client device based on which the TWT negotiation is rejected, wherein the maintained role information indicates a second user role of the additional client device based on which the TWT negotiation is accepted, and wherein the second user role is different from the first user role.

4. The method defined in claim 1, wherein rejecting the TWT negotiation is based on a number of client devices of an additional role in the plurality of client devices meeting a threshold.

5. The method defined in claim 4, wherein the additional role is a preferred role and wherein the role is a non-preferred role.

6. The method defined in claim 4, wherein the maintained role information comprises the number of client devices of the additional role in the plurality of client devices.

7. The method defined in claim 4 further comprising:
based on the number of client devices of the additional role not meeting the threshold, accepting the TWT negotiation with the given client device.

8. The method defined in claim 7 further comprising:
based on the number of client devices of the additional role not meeting the threshold, accepting a TWT negotiation with an additional client device of the additional role in the plurality of client devices.

9. The method defined in claim 8 further comprising:
based on the number of client devices of the additional role meeting the threshold, accepting the TWT negotiation with the additional client device of the additional role.

10. The method defined in claim 1 further comprising:
after rejecting the TWT negotiation with the given client device, performing a power save mode operation with the given client device.

11. A wireless access point comprising:
wireless communication circuitry;
memory circuitry configured to store a client device database containing a first role for a first connected client device and containing a second role for a second connected client device; and
processing circuitry coupled to the wireless communication circuitry and the memory circuitry and configured to:
accept or initiate a negotiation with the first connected client device based on the first role; and
reject or not initiate a negotiation with the second connected client device based on the second role.

12. The wireless access point defined in claim 11, wherein the negotiations with the first and second connected client devices comprise negotiations for scheduling a time period for at least one of uplink data reception and downlink data transmission.

13. The wireless access point defined in claim 12, wherein the negotiations are target wake time (TWT) negotiations and the scheduled time period comprises a TWT service period.

14. The wireless access point defined in claim 11, wherein the processing circuitry is configured to reject or not initiate the negotiation with the second connected client device when a number of connected client devices of the first role exceeds a threshold.

15. The wireless access point defined in claim 14, wherein the processing circuitry is configured to accept or initiate the negotiation with the second connected client device when the number of connected client devices of the first role is below the threshold.

16. The wireless access point defined in claim 11, wherein the processing circuitry is configured to accept the negotiation with the first connected client device by transmitting, using the wireless communication circuitry, an accept message in response to a setup message received from the first connected client device and wherein the processing circuitry is configured to reject the negotiation with the second connected client device by transmitting, using the wireless communication circuitry, an reject message in response to a setup message received from the second connected client device.

17. A wireless access point comprising:
wireless communication circuitry;
memory circuitry configured to store a client device database containing role information for a first set of connected client devices and for a second set of connected client devices; and
processing circuitry coupled to the wireless communication circuitry and the memory circuitry and configured to:
indiscriminately provide a service to any client device in the first and second sets of connected client devices based on the client device database, in a first state, satisfying a criterion; and
selectively provide the service to any client device in the first set of connected client devices based on the client device database, in a second state, not satisfying the criterion.

18. The wireless access point defined in claim 17, wherein the service comprises a target wake time operation.

19. The wireless access point defined in claim 17, wherein the client device database, in the first state, has a first number of connected client devices in the first set, wherein the client device database, in the second state, has a second number of connected client devices in the second set, and wherein the second number is greater than the first number.

20. The wireless access point defined in claim 17, wherein the processing circuitry is configured to obtain the role information in the client device database as part of network access authentication operations for the first and second sets of connected client devices.
